(19) United States
(12) Patent Application Publication
(10) Pub. No.: US 2016/0010849 A1
(43) Pub. Date: Jan. 14, 2016

(54) Pole Sander With Light Attachment

(71) Applicant: Dale Snellenberger, Manchester, CT (US)

(72) Inventor: Dale Snellenberger, Manchester, CT (US)

(21) Appl. No.: 14/795,239

(22) Filed: Jul. 9, 2015

Related U.S. Application Data
(60) Provisional application No. 62/022,336, filed on Jul. 9, 2014.

(51) Int. Cl. F21V 33/00; F21V 23/04; F21V 19/00; B24B 23/02

(52) U.S. Cl. CPC F21V 33/0084; B24B 23/02; F21V 23/04; F21V 19/006

(57) ABSTRACT

A pole sander with a light attachment is provided. The pole sander includes a shaft having a proximal end and a distal end. The proximal end includes a sander head that is rotatably driven by a motor disposed within said sanding head configured to sand a surface to achieve a smooth surface. Along the length of the shaft towards the proximal end, the shaft further includes a light attachment configured to provide light to the proximal end. The light attachment includes a substantially cone-shaped housing having a socket configured to receive a light source. The socket is electrically connected to a power source that provides the light source with an electrical current allowing the same to produce light. The housing is placed in contact with the shaft to direct the light attachment towards the sanding head to improve visibility.

### CROSS REFERENCE TO RELATED APPLICATION

This application claims the benefit of U.S. Provisional Application No. 62/022,335 filed on Jul. 9, 2014. The above identified patent application is herein incorporated by reference in its entirety to provide continuity of disclosure.

### BACKGROUND OF THE INVENTION

### Field of the Invention

The present invention relates to power tools. More specifically, the present invention pertains to an improved pole sander that has a light attachment that directs light towards a region being sanded to prevent mistakes due to visibility issues.

A sander is a specific type of power tool used to smooth materials and surfaces, such as woods and plastics. Sanders are also used to remove small amounts of waste material. Typically, sanders use sandpaper or the like to smooth surfaces by abrasion. While sanding drywall is not necessarily a complicated procedure, it can be time-consuming, tiring, and dusty. When sanding drywall, the actual freshly taped drywall itself it not being sanded, however sanding drywall specifically relates to sanding and smoothing the joint compound used for taping the drywalls together. Therefore, removing these taped seams often takes skill and care.

In order to sand a drywall efficiently, it is essential to have a brightly lit work area. Being able to identify the tape seams to be sanded is imperative to sanding efficiently and preventing mistakes due to visibility issues. However, often sanding is performed in a dimly lit area, especially in a construction area where sunlight dictates the available lighting. As an alternative, some people use utility lights to provide more lighting, however, these utility lights need to be regularly moved and repositioned In order to provide satisfactory lighting. Therefore, sanding a drywall often takes longer than expected and there exists a need for providing continuous and directed lighting while sanding a drywall.

The present invention provides a pole sander with a light attachment. The pole sander includes a shaft having a proximal end and a distal end. The proximal end includes a sander head that is rotatably driven by a motor to sand a surface to achieve a smooth surface. Along the length of the shaft towards the proximal end, the shaft further includes a female fastener, wherein a light attachment having an aligning male fastener is removably attached and serves to guide light towards the proximal end. The light attachment includes a substantially cone-shaped housing having a socket configured to receive a light source. The socket is electrically connected to a power source that provides the light source with an electrical current allowing the same to produce light. The housing is placed in contact with the shaft to direct the light attachment towards the sanding head to prevent mistakes due to visibility issues.

### SUMMARY OF THE INVENTION

In view of the foregoing disadvantages inherent in the known types of pole sanders now present in the prior art, the present invention provides a new and improved pole sander with a light attachment wherein the same can be utilized for directing light towards an area to be sanded.

It is therefore an object of the invention to provide a new and improved pole sander that has all of the advantages of the prior art and none of the disadvantages.

Another object of the present invention is to provide a new and improved pole sander with a light attachment pivotally secured thereon.

Yet another object of the present invention is to provide a new and improved pole sander, wherein the light attachment is configured to direct light towards a sander head to prevent mistakes due to visibility issues.

Still yet another object of the present invention is to provide a new and improved pole sander, wherein the light attachment includes a housing having a socket configured to receive a light source.

Another object of the present invention is to provide a new and improved pole sander, wherein the socket is electrically connected to a power source that provides an electrical current to the light source to provide light.

A further object of the present invention is to provide a new and improved pole sander, wherein the housing is pivotally joined with the shaft of the pole sander to direct light towards the sanding head to provide better illumination.

Yet a further object of the present invention is to provide a new and improved pole sander that is easy and convenient to use.

Still yet another object of the present invention is to provide a new and improved pole sander wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows an overhead perspective of the present invention and a close-up perspective of the light attachment.

FIG. 2 shows a side perspective of the present invention.

FIG. 3 shows a side perspective of the present invention in operation.

### DETAILED DESCRIPTION OF THE INVENTION

References are made herein to the attached drawings. Like reference numerals are used throughout the drawings to depict like or similar elements of the pole sander. For the purposes of presenting a brief and clear description of the present invention, the preferred embodiment will be discussed as used for sanding a drywall surface and providing light for doing the same. The figures are intended for representative purposes only and should not be considered to be limiting in any respect.

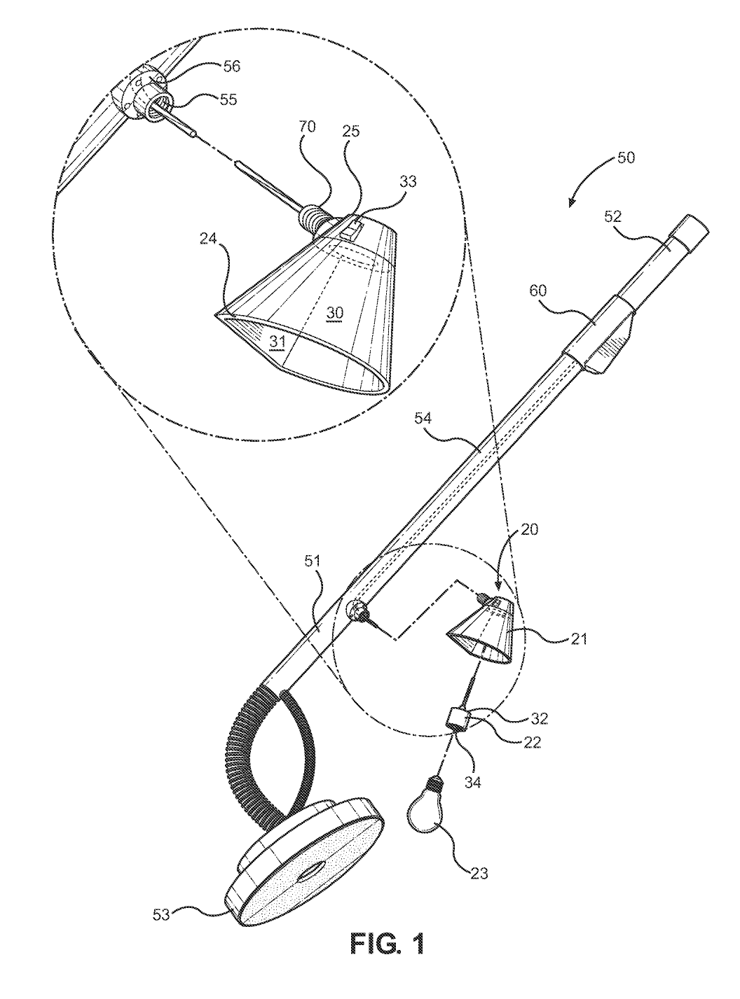

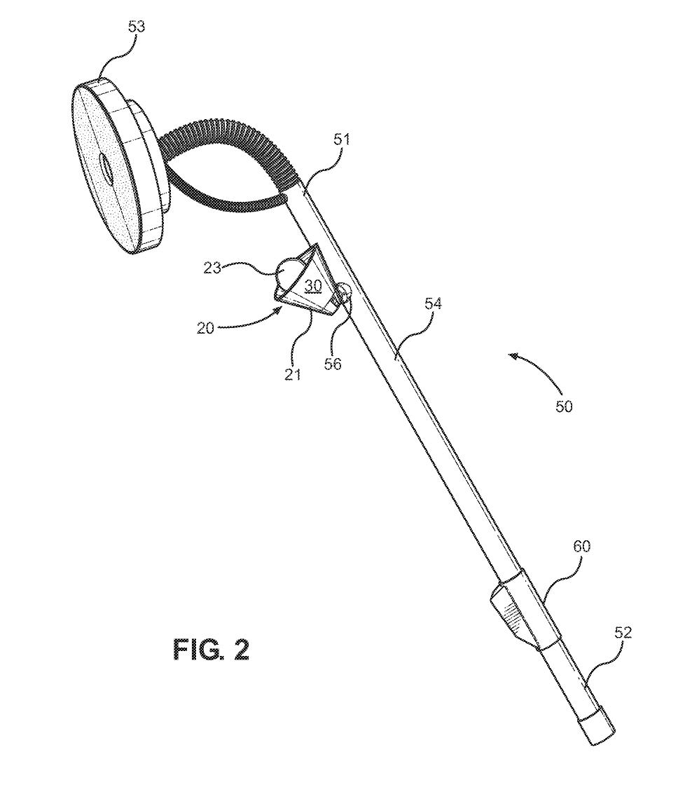

Referring now to FIGS. 1 and 2, there are shown an overhead perspective and a side perspective of the pole sander 50. The pole sander 50 comprises a shaft 54 having a proximal end 51, a distal end 52. The shaft 54 further includes a power source or is adapted for connection to a power source. Preferably, the power source includes wiring and cords to allow for the pole sander 50 to be electrically connected to a power outlet. The distal end 52 includes a handle 60 that is configured to allow a user to hand grip while sanding. The proximal end 51 includes a sanding head 53, which includes a disc shaped member rotatably driven by a motor. The disc-shaped member is used to support sand paper, or the like, thereon to sand a surface to achieve a smooth surface. Along the length of the shaft 54 towards the proximal end 51, the shaft 54 includes a female fastener, preferably a flange 56 having an opening 55 with female threaded elements configured to removably fasten a light attachment 20 thereon.

The light attachment 20 comprises a housing 21 and a socket 22, wherein a light source 23 is removably attached therein. The housing 21 is substantially a cone shape having an exterior surface 30, a coextensive interior surface 31, a wide open end 24 and a narrow open end 25 forming an interior volume. The exterior surface 30 on the narrow open end 25 includes an aligning male fastener that allows the light attachment 20 to be removably attached. Preferably, the aligning male fastener is a screw 70 having male threaded elements that align with the female threaded elements of the opening 55. It is recognized that male and female threaded elements are not the only means for removable attachment, and therefore it is contemplated that other embodiments are alternative composed of other suitable fasteners.

When the light attachment 20 is removably fastened to the opening 55 of the shaft 54, the exterior surface 30 is placed in contact with the shaft 54. Placing the exterior surface 30 in contact with the shaft 54 is particularly important as it affixes the light attachment 20 to be pointed towards the proximal end 51. Therefore, this allows the light attachment 20 to provide and direct light to the general area that a user is sanding. The interior surface 31 is configured to diffuse the light that the light attachment 20 emits and direct the light towards the proximal end 51 having the sanding head 53. In this way, the interior surface 31 is particularly advantageous as it properly directs the light towards an area that a user is operating and helps limit the possible mistakes due to visibility issues.

The wide open end 24 provides access to the interior volume, wherein the interior volume is configured to receive a light source 23 and removably connects the same to the socket 22 to provide light. An incandescent bulb is shown in the illustrated embodiment, however, it is contemplated that embodiments of the light attachment 20 include other types of electric light, such as, but not limited to fluorescent lamps, compact fluorescents lamps, cold cathode fluorescent lamps, high-intensity discharge lamps, and light-emitting diode lamps.

The socket 22 is positioned on the narrow open end 25 and has a cylindrical shape having a lower end 34 and an upper end 32 forming a hollow interior. The socket 22 is configured to provide an electric current to the light source 23 and to support the light source 23 within the housing 21. The socket 22 is internally threaded at its lower end 34 in order to receive the threaded base of the light source 23. It is also recognized that many different types of light sources include different sizes and shapes of bases that include, but are not limited to, screw cap, small Edison screw, bayonet, and small bayonet, wherein alternative embodiments of the housing 21 includes sockets 22 having the corresponding fitting to receive these types of bases.

The socket 22 is electrically connected to the power source configured to supply the light source 23 with an electrical current. Preferably, the socket 22 is electrically connected to a power source through the opening 55, wherein the pole sander 50 is electrically connected to the power source configured to activate and deactivate the pole sander 50 and the light attachment 20. Preferably, the light attachment 20 includes an on/off switch 33 that is accessible on the exterior surface 30. The on/off switch 33 is configured to activate the power source to supply the light source 23 with an electrical current to provide light. In the preferred embodiment, the on/off switch 33 is a rocker switch, however, in alternative embodiments, the on/off switch 33 includes other suitable types of on/off switches, including a toggle switch and a rotary switch.

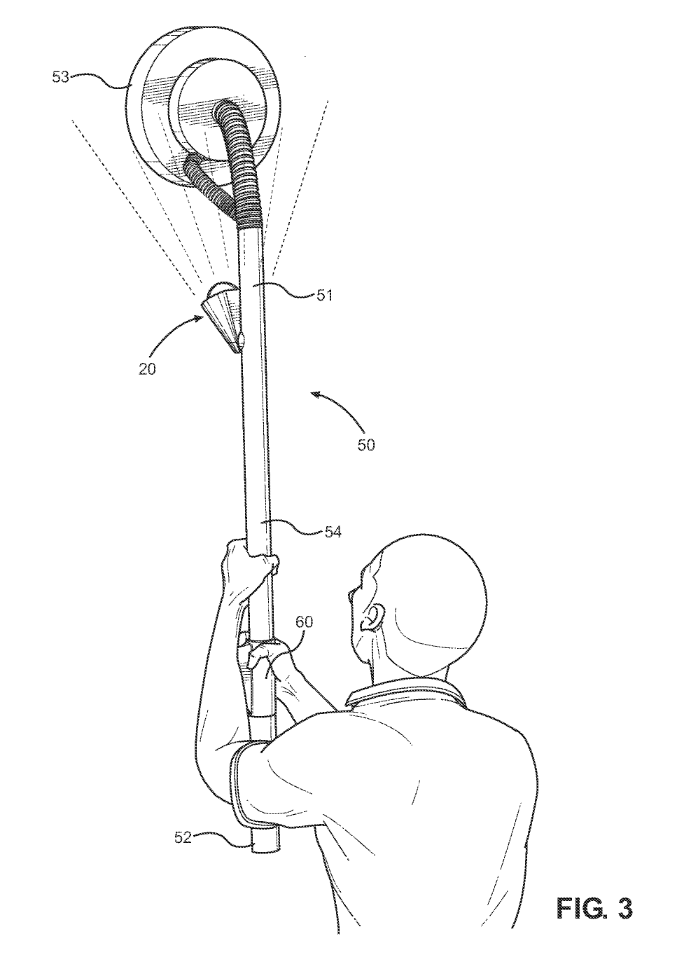

Referring now to FIG. 3, there is shown a side perspective of the pole sander 50 in operation with the light attachment 20 activated. The pole sander 50 includes a shaft 54 having a proximal end 51 and a distal end 52. The distal end 52 includes a handle 60 that allows a user to hand grip thereon while sanding a surface The proximal end 51 includes a sanding head 53 that is configured to smooth a drywall surface. The light attachment 20 is attached along the length of the shaft towards the proximal end 51. The light attachment 20 includes a housing that is substantially cone shaped that is configured to direct light towards the proximal end 51 having the sanding head 53. In this way, the light attachment 20 is particularly advantageous as it allows a user to work more proficiently and effectively in dark areas, and therefore, prevent mistakes that may slow down the completion of the task.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pole sander with a light attachment, comprising:
a shaft having a proximal end and a distal end;
said proximal end comprising a sander head configured to smooth a surface;
wherein said sanding head is rotatably driven by a motor disposed within said sanding head;
a light attachment removably secured to said shaft;
wherein said light attachment includes a light source directed towards said proximal end of said shaft.

2) The pole sander with a light attachment of claim 1, wherein:
said light attachment comprises a housing having a substantially cone-shape having an exterior surface, a coextensive interior surface, a wide open end, and a narrow open end forming an interior volume;
wherein said housing is configured to be placed in contact with said shaft.

3) The pole sander with a light attachment of claim 2, wherein:
said narrow end includes a socket configured to receive a light source to be situated within said interior volume;
wherein said housing is configured to direct said light source towards said proximal end and said sanding head to provide lighting for the same.

4) The pole sander with a light attachment of claim 3, wherein said socket is electrically connected to a power source to provide an electrical current for said light source;
wherein said power source is also configured to power said motor of said sanding head.

5) The pole sander with a light attachment of claim 4, wherein said socket includes an on/off switch configured to activate and deactivate with said light attachment.

6) The pole sander with a light attachment of claim 1, wherein said light attachment removably secured to said proximal end of said shaft by a female fastener.

7) The pole sander with a light attachment of claim 6, wherein said female fastener includes a flange forming an opening have female threaded elements.

8) The pole sander with a light attachment of claim 7, wherein said light attachment includes an aligning male fastener that corresponds with said female fastener and is configured to removably fasten said light attachment on said shaft.
